(19) United States
(12) Patent Application Publication
(10) Pub. No.: US 2023/0294471 A1
(43) Pub. Date: Sep. 21, 2023

(54) METHOD FOR CONTROLLING AIR SUSPENSIONS, AIR SUSPENSION CONTROLLER, AIR SUSPENSION SYSTEM, VEHICLE, COMPUTER PROGRAM, AND COMPUTER-READABLE MEDIUM

(71) Applicant: Volvo Truck Corporation, Göteborg (SE)

(72) Inventor: Hiroo YAMAZAKI, Saitama (JP)

(21) Appl. No.: 18/019,114

(22) PCT Filed: Sep. 7, 2020
(86) PCT No.: PCT/JP2020/033764

§ 371 Date: Feb. 1, 2023

(51) Int. Cl. B60G 17/016; B60G 17/015

(52) U.S. Cl. CPC B60G 17/0162; B60G 17/0155; B60G 2202/242; B60G 2400/41; B60G 2400/0511; B60G 2202/152

(57) ABSTRACT

An electronic control unit containing a microcomputer performs: calculating operation variables of left and right air springs of air suspensions based on a steering angle and a roll angle of a vehicle; and controlling air pressures of the left and right air springs in accordance with the calculated operation variables.

### TECHNICAL FIELD

The present invention relates to a method for controlling air suspensions, an air suspension controller, an air suspension system, and a vehicle equipped with the air suspension system. The present invention also relates to a computer program for controlling air suspensions and a computer-readable medium carrying the computer program.

### BACKGROUND ART

Some vehicles, such as trucks and buses, are equipped with an air suspension system that uses air springs (air bellows) in order to enhance ride comfort and to prevent the height of the vehicle from changing depending on how much load the vehicle is currently carrying. Specifically, as disclosed in JP 2013-154834 A (PTL 1), in a vehicle equipped with an air suspension system, the air suspension system adjusts the air pressures of the left and right air springs in accordance with lateral acceleration determined based on the vehicle speed and the steering angle, thereby providing a more natural driving experience and ensuring improved stability of the vehicle as well as reducing excess centrifugal acceleration on the load when the vehicle turns.

### CITATION LIST

### Patent Literature

PTL 1: JP 2013-154834 A

### SUMMARY OF INVENTION

### Technical Problem

In general, the stability of a vehicle may decrease not only when the vehicle turns, but also when the vehicle travels straight while receiving a crosswind. However, a typical response of the driver of the vehicle to the latter situation is that the driver steers just slightly to windward to counter the crosswind. As such, in this situation, only a relatively small lateral acceleration is likely to be determined based on the vehicle speed and the steering angle. Accordingly, the technique disclosed in PTL 1 may be unable to suitably adjust the air pressures of the left and right air springs of a vehicle travelling while receiving a crosswind, and thus is less likely to improve the stability of the vehicle in such a situation.

Therefore, an object of the present invention is to provide a method for controlling air suspensions, an air suspension controller, and an air suspension system, and a vehicle equipped with the air suspension system, a computer program for controlling air suspensions, and a computer-readable medium carrying the computer program, each of which ensures improved stability of the vehicle even when it travels while receiving a crosswind.

### Solution to Problem

According to a first aspect of the present invention, an electronic control unit containing a microcomputer performs: calculating operation variables of left and right air springs of air suspensions based on a steering angle and a roll angle of a vehicle; and controlling air pressures of the left and right air springs in accordance with the calculated operation variables.

According to a second aspect of the present invention, an air suspension controller comprises: a sensor configured to measure a steering angle of a vehicle; and an electronic control unit containing a microcomputer. The electronic control unit is configured to: estimate a roll angle by applying a Kalman filter to the steering angle measured by the sensor; calculate operation variables of left and right air springs of air suspensions based on the measured steering angle and the estimated roll angle; and control air pressures of the left and right air springs in accordance with the calculated operation variables.

According to a third aspect of the present invention, an air suspension system comprises: air suspensions mounted on a vehicle; an air reservoir configured to store air; magnetic valves; a sensor configured to measure a steering angle of a vehicle; and an electronic control unit containing a microcomputer. Each of the magnetic valves is configured to control a flow rate of air supplied from the air reservoir to left or right air springs of the air suspensions and a flow rate of air discharged from the air springs. The electronic control unit is configured to: estimate a roll angle by applying a Kalman filter to a yaw rate and the steering angle measured by the sensor; calculate operation variables of the left and right air springs of the air suspensions based on the measured steering angle and the estimated roll angle; and control air pressures of the left and right air springs in accordance with the calculated operation variables by outputting actuation signals individually to the magnetic valves.

According to a fourth aspect of the present invention, a vehicle is equipped with the air suspension system.

According to a fifth aspect of the present invention, a computer program comprises a program code which, when executed on a computer, causes the computer to perform the above air suspension control. A computer-readable medium carries the computer program.

### Advantageous Effects of Invention

According to the present invention, it is possible to ensure improved stability of a vehicle even when the vehicle travels while receiving a crosswind.

### BRIEF DESCRIPTION OF DRAWINGS

FIG. 1 is a perspective view of an example of a truck.

FIG. 2 is a side view showing an example of the chassis of the truck.

FIG. 3 is a schematic diagram of an example of an air suspension control system.

FIG. 4 is a block diagram of an example of an electronic control unit.

FIG. 5 is a perspective view showing an example of an analytical model of the truck.

FIG. 6 is a control block diagram for air suspension control.

FIG. 7 is a flowchart of an example of air suspension control processing.

FIG. 8 illustrates a truck which is caused to roll by a crosswind.

FIG. 9 illustrates time-series estimates of the sideslip angle, the yaw rate, and the roll angle.

FIG. 10 illustrates time-series estimates of the sideslip angle, the roll angular velocity, and the roll angle.

### DESCRIPTION OF EMBODIMENTS

Hereinafter, an embodiment for implementing the present invention will be described in detail with reference to the accompanying drawings.

FIG. 1 shows an example of a truck 100 equipped with an air suspension system. The truck 100 is an example of a vehicle to which the present invention is applied. The vehicle to which the present invention is applied is not limited to the truck 100, but may be a passenger car, a bus, a construction machine, or the like equipped with an air suspension system.

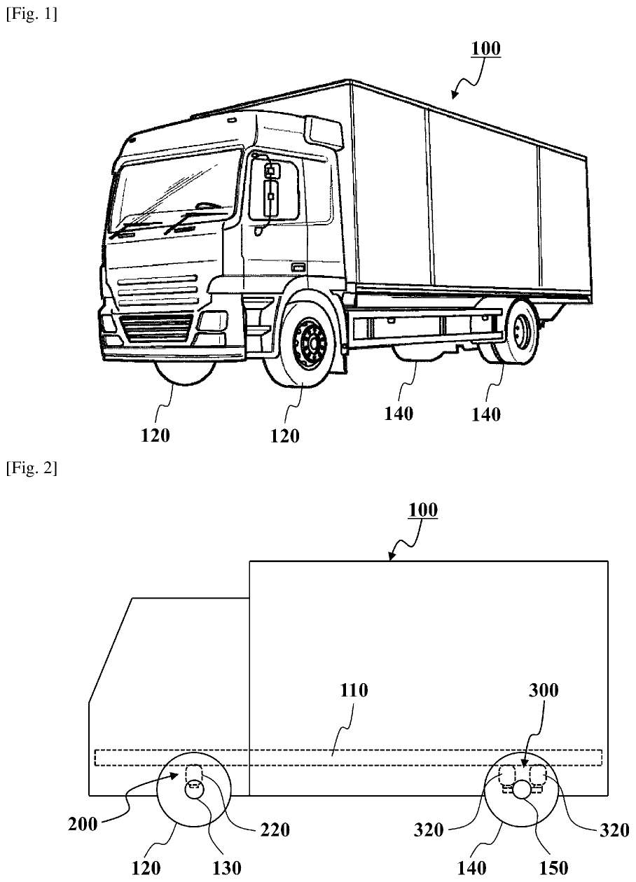

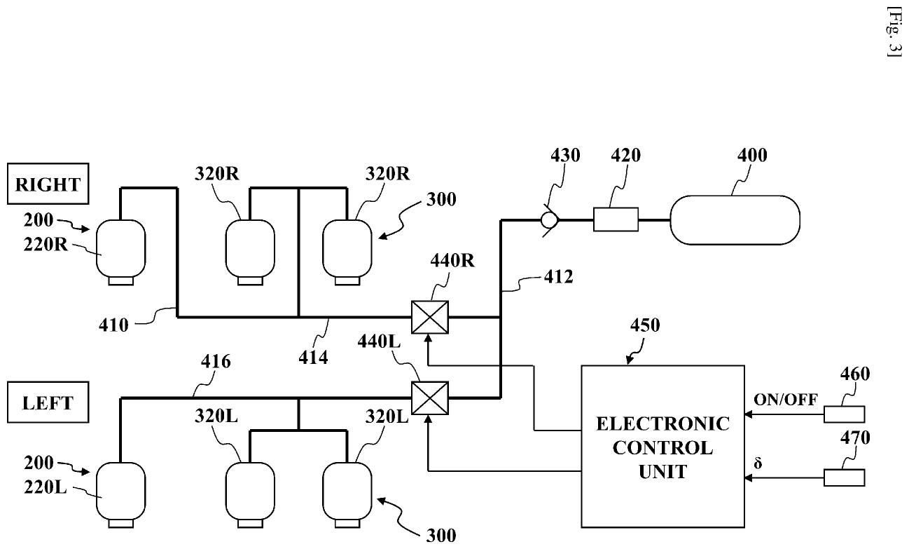

As shown in FIG. 2, the chassis of the truck 100 includes a ladder-shaped frame 110 extending in the longitudinal direction of the truck 100, a front axle 130 having left and right hubs to which a pair of front wheels 120 are detachably fastened, and a rear axle 150 having left and right hubs to which a pair of rear wheels 140 are detachably fastened. The left and right ends of the front axle 130 are coupled to predetermined positions in a front portion of the frame 110 via front air suspensions (referred to as “front suspensions” below) 200. The left and right ends of the rear axle 150 are coupled to predetermined positions in a rear portion of the frame 110 via rear air suspensions (referred to as “rear suspensions” below) 300.

Each of the front suspensions 200, which are disposed on the left and right sides of the truck 100, has a single air spring 220 which connects the front axle 130 to the frame 110. Each of the rear suspensions 300, which are disposed on the left and right sides of the truck 100, has two air springs 320 which connect the rear axle 150 to the frame 110. The air springs 320 are spaced apart from each other by a predetermined distance in the longitudinal direction of the truck 100. The air springs 220 and 320 may be air bellows, for example.

FIG. 3 shows an example of an air suspension control system mounted on the truck 100. In the following description, when it is necessary to distinguish the left and right of the truck 100, the air spring 220 of the front suspension 200 disposed on the right side of the truck 100 will be referred to as “air spring 220R”, and the air spring 220 of the front suspension 200 disposed on the left side of the truck 100 will be referred to as “air spring 220L”. Similarly, the air springs 320 of the rear suspension 300 disposed on the right side of the truck 100 will be referred to as “air springs 320R”, and the air springs 320 of the rear suspension 300 disposed on the left side of the truck 100 will be referred to as “air springs 320L”.

An air reservoir (air tank) 400 for storing air to be supplied to the front suspensions 200 and the rear suspensions 300 is mounted at a predetermined position of the truck 100. The air reservoir 400 is supplied with air at a pressure adjusted to a predetermined level from an air compressor driven by the engine (not shown), so that the pressure of the air supplied from the air reservoir 400 is substantially constant. Through an air pipe 410 that is divided into right and left branches at some intermediate point, the air reservoir 400 is connected to the air springs 220R, 320R disposed on the right side of the truck 100 and to the air springs 220L, 320L disposed on the left side of the truck 100.

Specifically, the air pipe 410 includes a first air pipe 412, a second air pipe 414, and a third air pipe 416. One end of the first air pipe 412 is connected to the air reservoir 400. The other end of the first air pipe 412 is connected to ends of two branch pipes: i.e., one end of the second air pipe 414, which extends to the right of the truck 100, and one end of the third air pipe 416, which extends to the left of the truck 100. The second air pipe 414, which is the branch pipe extending to the right of the truck 100, is further divided into branches at a point closer to the other end: one branch is connected to the air spring 220R of the front suspension 200 on the right side; and the other branch is connected to the two air springs 320R of the rear suspension 300 on the right side. The third air pipe 416, which is the branch pipe extending to the left of the truck 100, is further divided into branches at a point closer to the other end: one branch is connected to the air spring 220L of the front suspension 200 on the left side; and the other branch is connected to the two air springs 320L of the rear suspension 300 on the left side.

The first air pipe 412 of the air pipe 410 is provided with a protection valve 420 for addressing air failure and a check valve 430 for preventing air from flowing back to the air reservoir 400. The protection valve 420 and the check valve 430 are disposed in this order in the direction from the air reservoir 400 to the front suspensions 200 and the rear suspensions 300. The second air pipe 414, which is the branch pipe extending to the right of the truck 100, is provided with a magnetic valve 440R. The third air pipe 416, which is the branch pipe extending to the left of the truck 100, is provided with a magnetic valve 440L. Each of the magnetic valves 440R, 440L includes a solenoid therein. The magnetic valve 440R is configured to control the flow rate of air supplied from the air reservoir 400 to the air spring 220R of the front suspension 200 on the right side and to the air springs 320R of the rear suspension 300 on the right side, and to control the flow rate of air discharged from the air springs 220R, 320R. The magnetic valve 440L is configured to control the flow rate of air supplied from the air reservoir 400 to the air spring 220L of the front suspension 200 on the left side and to the air springs 320L of the rear suspension 300 on the left side, and to control the flow rate of air discharged from the air springs 220L, 320L.

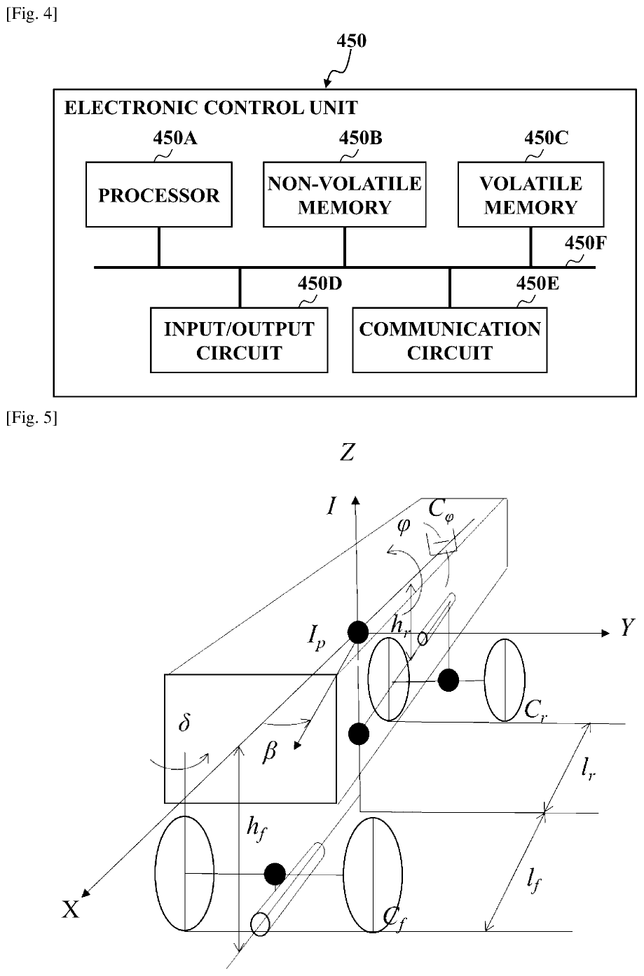

An electronic control unit 450 containing a microcomputer is mounted at a predetermined position of the truck 100. As shown in FIG. 4, the electronic control unit 450 includes therein a processor 450A such as a central processing unit (CPU), a non-volatile memory 450B, a volatile memory 450C, an input/output circuit 450D, a communication circuit 450E, and an internal bus 450F communicatively connecting these components with each other.

The processor 450A is hardware that executes a set of instructions (e.g., for data transfer, arithmetic processing, data processing, and data control and management) described in an application program. The processor 450A includes an arithmetic unit, a register that stores instructions and data, peripheral circuits, and the like. The non-volatile memory 450B is formed, for example, of a flash read only memory (ROM), which is capable of retaining data even after it is powered off. The non-volatile memory 450B retains an application program (computer program) for implementing an air suspension controller. The volatile memory 450C is formed, for example, of a dynamic random access memory (RAM), which loses data retained therein when it is powered off. The volatile memory 450C provides a temporary storage area for data from arithmetic operations of the processor 450A.

The input/output circuit 450D includes an A/D converter, a D/A converter, a D/D converter, and the like. The input/output circuit 450D provides functionality to input and output analog and digital signals to external devices. The communication circuit 450E may include a controller area network (CAN) transceiver, for example. The communication circuit 450E provides functionality to connect to an on-board network of the vehicle. The internal bus 450F serves as a path for exchanging data between the components connected thereto. The internal bus 450F includes an address bus for transferring addresses, a data bus for transferring data, and a control bus for exchanging control information and timing information specifying when to actually perform input/output operations through the address bus and/or the data bus.

Furthermore, a switch 460 and a steering angle sensor 470 are mounted at predetermined positions of the truck 100. The switch 460 allows selecting whether to perform air suspension control according to this embodiment, as desired. The steering angle sensor 470 is configured to measure a steering angle δ [rad] of the front wheels 120 of the truck 100. The switch 460 is configured to be operated by the driver of the truck 100 or the like, and to output, for example, either an ON signal for instructing to perform the air suspension control according to this embodiment or an OFF signal for instructing not to perform the air suspension control. The signals output from the switch 460 and the steering angle sensor 470 are input to the processor 450A through the input/output circuit 450D of the electronic control unit 450.

First, the outline of the air suspension control performed by the processor 450A of the electronic control unit 450 in accordance with the application program stored in the non-volatile memory 450B will be described.

The processor 450A of the electronic control unit 450 reads the steering angle δ from the steering angle sensor 470 and estimates a roll angle φ [rad] of the truck 100 by applying a Kalman filter to the steering angle δ. Then, based on the steering angle δ and the roll angle φ of the truck 100, the processor 450A of the electronic control unit 450 calculates an operation variable of the air springs 220R, 320R in the front suspension 200 and the rear suspension 300 disposed on the right side, and an operation variable of the air springs 220L, 320L in the front suspension 200 and the rear suspension 300 disposed on the left side. Then, the processor 450A of the electronic control unit 450 controls the air pressures of the right and left air springs 220R, 320R, 220L, 320L by outputting actuation signals individually to the magnetic valves 440R, 440L in accordance with the calculated operation variables. Note that, instead of estimating the roll angle φ [rad] by applying the Kalman filter to the steering angle δ, the processor 450A of the electronic control unit 450 may determine the roll angle φ based on a signal output from height sensors (not shown) disposed on the left and right sides of the truck 100, for example.

Next, the theory on which the air suspension control performed by the processor 450A of the electronic control unit 450 based will be described.

The continuous-time state equations representing the motion of the truck 100 may be expressed by the following differential equation:

\dot{x}=Ax+B

y=Cx [Math.1]

, where x is a state variable, A is a system matrix, B is a control matrix, and C is an observation matrix.

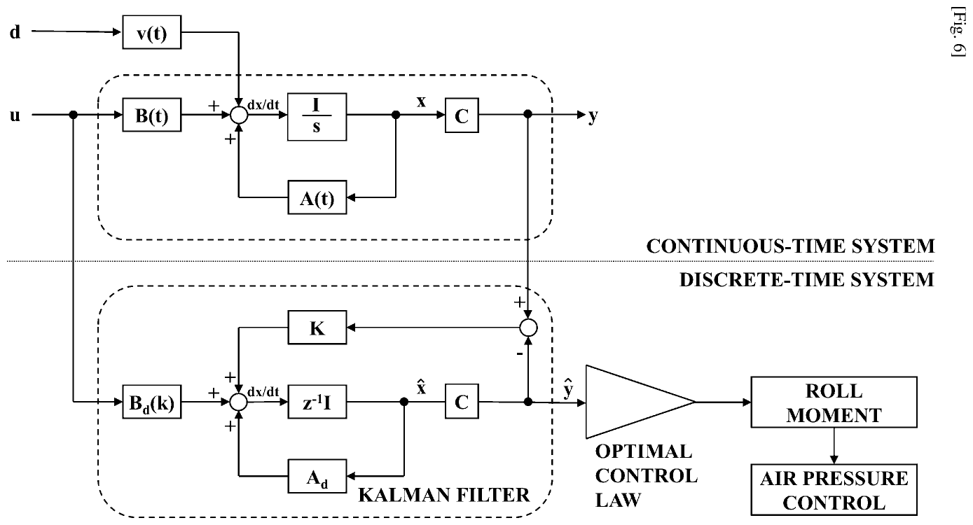

The continuous-time system matrix A and the continuous-time system control matrix B may be determined in the following manner based on an analytical model of the truck 100 as shown in FIG. 5.

The analytical model uses the parameters defined as below.
C_{f}: Cornering power [N] of the front wheels 120
Cᵣ: Cornering power [N] of the rear wheels 140
m: Vehicle mass [kg]
mₛ: Roll mass [kg]
φ: Roll angle [rad]
β: Sideslip angle [rad]
V: Vehicle speed [m/s]
r: Yaw rate [rad/s]
F_{f}: Lateral force [N] of the front wheels 120
Fᵣ: Lateral force [N] of the rear wheels 140
I: Vehicle inertia moment [kgm²]
Iₓ: Roll inertia moment [kgm²]
I_{z}: Yaw inertia moment [kgm²]
I_{φ}: Inertia moment about the roll axis [kgm²]
I_{f}: Distance [m] in the vehicle longitudinal direction from the gravitational center to the front axle 130
Iᵣ: Distance [m] in the vehicle longitudinal direction from the gravitational center to the rear axle 150
h_{f}: Distance [m] from the roll center to the front wheels 120
hᵣ: Distance [m] from the roll center to the rear wheels 140
hₛ: Distance [m] from the roll center to the gravitational center position
K_{φ}: Roll stiffness [Nm/rad]
C_{φ}: Roll damping coefficient [Nms/rad]
g: Gravitational acceleration [9.8 m/s²]

The equation of motion describing this analytical model may be expressed as follows:

$$mV ( \dot{β} + r ) = {F}_{f} + {F}_{r} \qquad [ Math . 2 ]$$

$${I}_{z} \dot{r} = {l}_{f} {F}_{f} - {l}_{r} {F}_{r}$$

$${I}_{x} \ddot{ϕ} = {F}_{f} {h}_{f} + {F}_{r} {h}_{r} - ( {K}_{ϕ} - mgh ) ϕ - {C}_{ϕ} \dot{ϕ}$$

$$h = \frac{( {h}_{f} {l}_{r} + {h}_{r} {l}_{f} )}{{l}_{f} + {l}_{r}}$$

The above equations of motion lead to the following equations:

$$\dot{β} = - 1 + \frac{1}{m V} {F}_{f} + \frac{1}{m V} {F}_{r} \qquad [ Math . 3 ]$$

$$\dot{r} = \frac{{l}_{f}}{{I}_{Z}} {F}_{f} - \frac{{l}_{r}}{{I}_{Z}} {F}_{r}$$

$$\ddot{ϕ} = - \frac{{C}_{ϕ}}{{I}_{x}} \dot{ϕ} - \frac{( {K}_{ϕ} - m g h )}{{I}_{x}} ϕ + \frac{{h}_{f}}{{I}_{x}} {F}_{f} + \frac{{h}_{r}}{{I}_{x}} {F}_{r}$$

The lateral acceleration of α_{f} [m/s²] of the front wheels 120 and the lateral acceleration αᵣ [m/s²] of the rear wheels 140 may be expressed by the following equations:

$${α}_{f} = δ - β - \frac{{l}_{f}}{V} r - \frac{{h}_{f}}{V} \dot{ϕ} \qquad [ Math . 4 ]$$

$${α}_{r} = - β + \frac{{l}_{f}}{V} r - \frac{{h}_{f}}{V} \dot{ϕ}$$

Based on the above, the continuous-time system matrix A and the continuous-time control matrix B may be expressed as follows:

$$[ Math . 5 ]$$

$$A = [ \begin{matrix}- \frac{\begin{matrix}2 ( {C}_{f} + \\ {C}_{r} )\end{matrix}}{mV} & - 1 - \frac{\begin{matrix}2 ( {C}_{f} {l}_{f} - \\ {C}_{r} {l}_{r} )\end{matrix}}{{mV}^{2}} & - \frac{\begin{matrix}2 ( {h}_{f} {C}_{f} - \\ {h}_{r} {C}_{r} )\end{matrix}}{{mV}^{2}} & 0 \\ - \frac{\begin{matrix}2 ( {C}_{f} {l}_{f} - \\ {C}_{r} {l}_{r} )\end{matrix}}{I} & - \frac{\begin{matrix}2 ( {C}_{f} {l}_{f}^{2} + \\ {C}_{r} {l}_{r}^{2} )\end{matrix}}{{I}_{ϕ}} & - \frac{\begin{matrix}2 ( {h}_{f} {l}_{f} {C}_{f} - \\ {h}_{r} {l}_{r} {C}_{r} )\end{matrix}}{{I}_{ϕ}} & 0 \\ - \frac{\begin{matrix}2 ( {h}_{f} {C}_{f} + \\ {h}_{r} {C}_{r} )\end{matrix}}{{I}_{ϕ}} & - \frac{2 {h}_{s} V}{{I}_{ϕ}} & - \frac{\begin{matrix}( {C}_{ϕ} / {I}_{ϕ} + \\ 2 ( {h}_{f} {C}_{f} + \\ {h}_{r} {C}_{r} ) / ( {I}_{ϕ} V ) )\end{matrix}}{{I}_{ϕ}} & ( - {K}_{ϕ} + {msgh}_{s} ) / {I}_{ϕ} \\ 0 & 0 & 1 & 0\end{matrix} ] \text{}$$

$$B = [ \begin{matrix}\frac{2 {C}_{f}}{m V} & 0 & 0 \\ \frac{2 {C}_{r}}{m V} & \frac{1}{I} & 0 \\ \frac{2 {h}_{f} {C}_{f}}{I} & 0 & \frac{2}{{I}_{ϕ}} \\ 0 & 0 & 0\end{matrix} ]$$

The above equation of motion is continuous-time differential equation, which is thus not applicable for use by the processor 450A of the electronic control unit 450. As such, the above continuous-time equation of motion should be transformed into a discrete-time equation of motion. The system matrix A and the control matrix B may be transformed into a discrete-time system matrix A_{d} and a discrete-time control matrix B_{d}, which give the following discrete-time state equation:

$$\hat{x} ( k + 1 ) = {A}_{d} \hat{x} ( k ) + {B}_{d} u ( k ) \qquad [ Math . 6 ]$$

$$y ( k ) = C x ( k )$$

$${A}_{d} = I + AT + \frac{1}{2 !} {( A T )}^{2} + … + \frac{1}{N !} {( A T )}^{N}$$

$${E}_{d} = I + \frac{1}{2 !} A T + \frac{1}{3 !} {( AT )}^{2} + … + \frac{1}{N !} {( AT )}^{N - 1}$$

$${B}_{d} = {E}_{d} TB$$

where T [s] represents a sampling time.

The discrete-time Kalman filter may be expressed by the following equation:

\hat{x}(k+1)=(A_{d}−KC)\hat{x}(k)+Ky(k)+B_{d}u(k) [Math.7]

, where K is a Kalman filter gain.

The Kalman filter gain K may be calculated as follows using the solution P of the following Riccati equation:

P=Q+A_{d}PA_{d}^{T}−PA_{d}^{T}PC(R+C^{T}PC)⁻¹C^{T}PA_{d}

K=(R+C^{T}PC)⁻¹C^{T}PA_{d} [Math.8]

, where Q represents a disturbance variance matrix, and R represents an observation noise variance matrix.

The system may be expressed by the following difference equation.

x(k+1)=A_{d}x(k)+B_{d}u(k) [Math.9]

The optimal control law of the system may be defined by the following equation:

u=−F\hat{x}(k) [Math.10]

, where F represents a feedback gain.

The feedback gain F may be determined based on the disturbance variance matrix Q and the observation noise variance matrix R that minimize J in the following equation.

$$J = \frac{1}{2} {\sum }_{k = 0}^{∞} \{ {x ( k )}^{T} Q x ( k ) + {Ru ( k )}^{2} \} \qquad [ Math . 11 ]$$

The feedback gain F is expressed by the following equation.

F=(R+B^{T}PB)⁻¹B^{T}PA [Math.12]

In the above equation representing the feedback gain F, P is a solution of the Riccati equation that may be represented as follows:

P=Q+A_{d}PA_{d}−A_{d}PB_{d}(R+B^{T}PB)B^{T}PA_{d [Math.}13]

The continuous-time state equation, discrete-time state equation, and optimal control law thus determined are stored and used in the electronic control unit 450. As a result, the control block for the air suspension control is implemented as shown in FIG. 6. This control block is configured to use an identity observer using a Kalman filter to reduce error in estimating the roll angle, thus providing a more accurate final estimate of the roll angle.

In a continuous-time system, an input variable u, such as the steering angle δ, is transformed to B(t)u(t) by the control matrix B(t); a disturbance d is adjusted to v(t)d(t) using a gain v(t); a state variable x, such as the sideslip angle β, the yaw rate r, or the roll angle φ, is transformed to A(t)x(t) by the system matrix A(t). B(t)u(t), v(t)d(t), and A(t)x(t) thus calculated are added together to obtain a differential value (dx/dt) of the state variable x. The differential value of the state variable x thus obtained is integrated using the identity matrix I and the Laplace operator s to obtain the state variable x. The state variable x thus obtained is transformed to Cx(t) by the observation matrix C. Then, Cx(t) is output as an output variable y, such as for the sideslip angle β, the yaw rate r, or the roll angle φ.

In a discrete-time system, the input variable u, such as the steering angle δ, is transformed to B_{d}u(t) by the control matrix B_{d}(k); each output variable y output from the continuous-time system is adjusted to Ky(k) using the Kalman filter gain K; a control variable x-hat, such as an estimate of the sideslip angle β, the yaw rate r, or the roll angle φ, is transformed to Cx-hat(k) by the observation matrix C, then adjusted to KCx-hat(k) using the Kalman filter gain K, and transformed to A_{d}x-hat(k) by the system matrix A_{d}. B_{d}u(k), Ky(k), and A_{d}x-hat(k) thus calculated are added together and CKx-hat(k) is subtracted from the resultant sum to obtain a differential value of the control variable x-hat. The differential value thus obtained is integrated by the Z-transform using the identity matrix I to obtain the control variable x-hat. The control variable x-hat thus obtained is transformed to Cx-hat(k) by the observation matrix C. Then, Cx-hat(k) is output as an output variable y-hat, such as for the estimate of the sideslip angle β, the yaw rate r, or the roll angle φ.

The output variables y-hat output from the discrete-time system are converted into a roll moment that causes the truck 100 to roll, in consideration of the feedback gain of the optimal control law. In accordance with the roll moment, the electronic control unit 450 controls the air pressures of the left and right air suspensions.

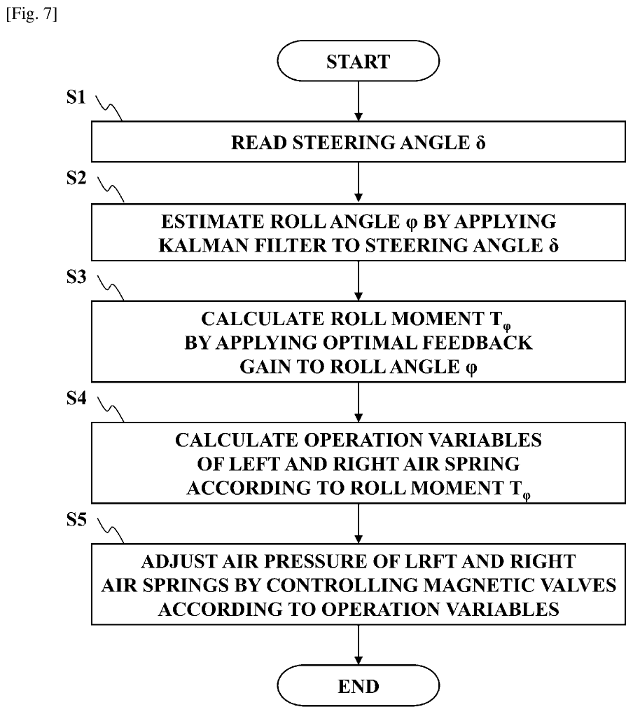

Triggered by the activation of the electronic control unit 450, the processor 450A of the electronic control unit 450 repeatedly performs air suspension control processing as illustrated in FIG. 7. Note that the air suspension control processing is performed only when the driver of the truck 100 or the like operates the switch 460 to instruct the electronic control unit 450 to perform the air suspension control according to this embodiment. Note also that the air suspension control processing described below is merely illustrative and the present invention is not limited to this.

In step 1 (abbreviated as “S1” in FIG. 7; the same applies to the other steps below), the processor 450A of the electronic control unit 450 reads the steering angle δ of the truck 100 from the steering angle sensor 470 through the input/output circuit 450D.

In step 2, the processor 450A of the electronic control unit 450 estimates the roll angle φ of the truck 100 by applying a Kalman filter to the steering angle δ. That is, in step 2, by using the Kalman filter, which is an infinite impulse response filter for estimating the state of a dynamic system from observed measurements that may contain errors, the processor 450A of the electronic control unit 450 estimates the roll angle φ, which is highly related to the steering angle δ. Step 2 is an example of the step of estimating the roll angle by applying a Kalman filter to the steering angle.

In step 3, by applying, to the roll angle φ estimated in step 2, the optimal control law (u=−Fx−hat(k)) that uses the feedback gain F, the processor 450A of the electronic control unit 450 calculates a roll moment T_{φ} that causes the truck 100 to roll.

In step 4, in accordance with the roll moment T_{φ} calculated in step 3, the processor 450A of the electronic control unit 450 calculates the operation variables of the left and right air springs respectively as follows.

The roll moment T_{φ} may be expressed by the following equation:

$${T}_{ϕ} = \frac{1}{2} {l}_{s} {A}_{s} ( {P}_{0} + Δ p ) - \frac{1}{2} {l}_{s} {A}_{s} ( {P}_{0} - Δ p ) , \qquad [ Math . 14 ]$$

where Aₛ [m²] is a pressure receiving area of the air springs, P₀ [Pa] is a reference air pressure of the air suspensions, lₛ [m] is a center-to-center distance between the left and right air springs, and Δp [Pa] is a differential pressure between the left and right air springs.

The above equation may be rewritten in the following form:

T_{ϕ}=lₛAₛΔp [Math.15]

Thus, the differential pressure Δp between the left and right air springs is given by the following equation:

$$Δ p = \frac{{T}_{ϕ}}{{l}_{s} {A}_{s}} = - \frac{1}{{l}_{s} {A}_{s}} ( {F}_{33} \hat{\dot{ϕ}} + {F}_{34} \hat{ϕ} ) , \qquad [ Math . 16 ]$$

where F₃₃ [dimensionless] is a feedback gain for a roll angular velocity, and F₃₄ [dimensionless] is a feedback gain for a roll angle.

Then, the processor 450A of the electronic control unit 450 calculates an operation variable that increases the air pressures of the air springs disposed on one of the left and right sides of the truck 100 by Δp, and an operation variable that reduces the air pressures of the air springs disposed on the other of the left and right sides of the truck 100 by Δp. Here, whether the air pressures of the air springs on the left or right side is increased (or reduced) depends on whether the roll angle φ estimated in step 2 is positive or negative.

In step 5, the processor 450A of the electronic control unit 450 adjusts the air pressures of the left and right air springs by controlling the magnetic valves 440R, 440L in accordance with the operation variables of the left and right air springs calculated in step 4.

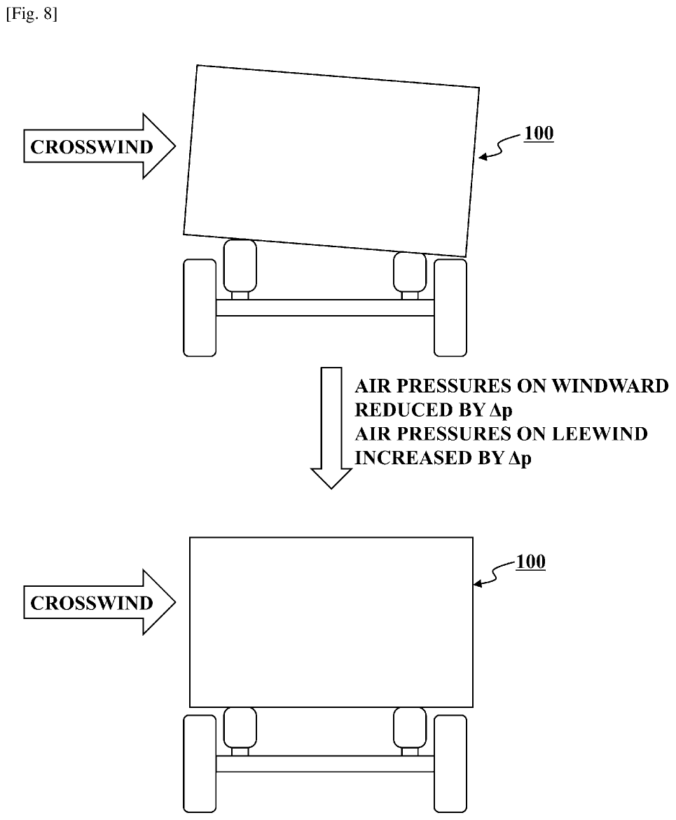

The air spring control processing described above provides an effect as shown in FIG. 8. That is, when the truck 100 traveling straight receives a crosswind and rolls to leeward, the air pressures of the air springs on the windward is reduced by Δp, and the air pressures of the air springs on the leeward is increased by Δp so as to at least partially compensate for the rolling of the truck 100. Otherwise, when the truck 100 receives a crosswind and rolls to leeward, a centrifugal force to tilt the truck 100 leeward acts on the gravitational center of the truck 100, and the driving stability of the truck 100 may be reduced. As such, the air spring control processing described above adjusts the air pressures of the left and right air springs so as to at least partially compensate for the rolling of the truck 100, thereby providing the effect of reducing such a centrifugal force acting on the gravitational center to ensure improved driving stability of the truck 100. The following describes simulation results given to verify this effect.

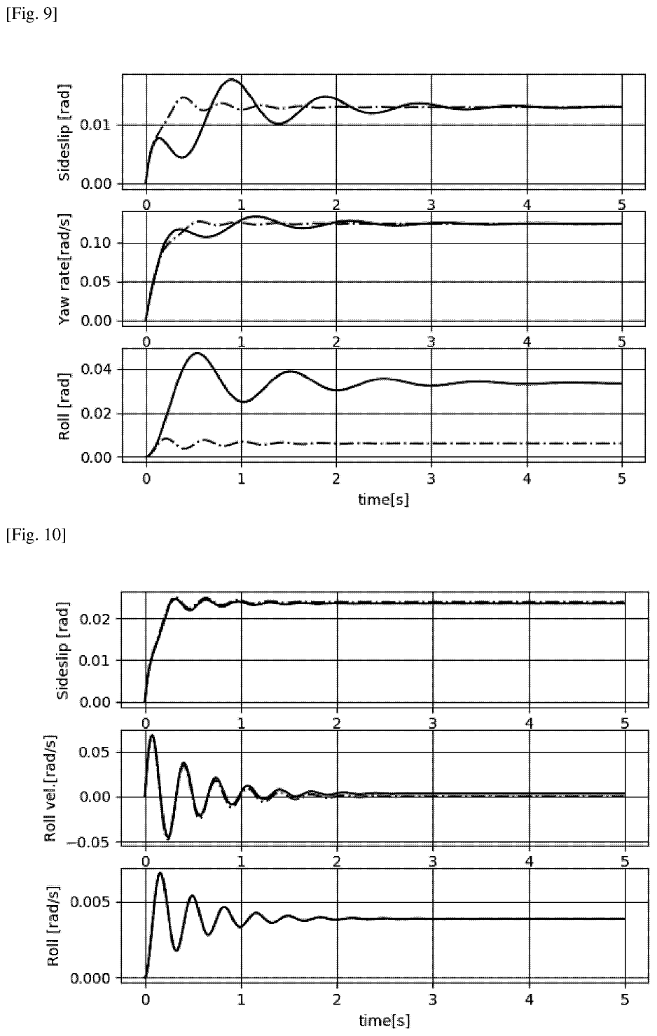

FIG. 9 shows how the sideslip angle β, the yaw rate r, and the roll angle φ change with time in response to the input of the steering angle δ. In FIG. 9, each solid line indicates the change of an actual numerical value (actual value), and each dashed-dotted line indicates the change of a value estimated using the Kalman filter. Examination of the graphs in FIG. 9 shows the following. Regarding the sideslip angle β and the yaw rate r, there initially is some difference between the actual value and the estimated value, but the difference gradually decreases over time, and eventually, the estimated value substantially matches the actual value. Regarding the roll angle φ, the estimated value is smaller than the actual value throughout the simulation time.

FIG. 10 shows how the sideslip angle β, the roll angular velocity φ-dot, and the roll angle φ change with time in response to the input of the steering angle δ. In FIG. 10, each solid line indicates the change of an actual numerical value (actual value), and each dashed-dotted line indicates the change of a value estimated using the Kalman filter. Examination of the graphs in FIG. 10 shows that, regarding all the sideslip angle β, the roll angular velocity φ-dot, and the roll angle φ, the estimated value substantially matches the actual value throughout the simulation time.

Thus, it may be understood that using the estimate of the roll angle φ obtained as above to control the air pressures of the air suspensions will provide an effect substantially equivalent to an effect expected to be provided by using a sensor configured to directly measure the roll angle to control the air pressures.

The application program for air suspension control may be stored in a computer-readable medium such as an SD card or a USB memory and sold commercially. As an alternative, the application program may be stored in a storage in a node connected to the Internet or the like and distributed from this node. In this case, the storage in the node is understood as an example of the computer-readable medium.

It should be noted that one skilled in the art could have easily understood that some of the technical features in the above embodiment may be omitted, replaced with one or more well-known technical features, and/or combined with one or more well-known technical features to provide various alternative embodiments.

For example, the truck 100 is not limited to a 4×2 truck (truck with a single front axle and a single rear axle) as shown in FIG. 1, but may be a 6×2 truck (truck with a single front axle and two rear axles or with two front axles and a single rear axle), a 8×4 truck (truck with two front axles and two rear axles), or the like. Still alternatively, the truck 100 may be an articulated vehicle such as a semi-trailer truck or a full-trailer truck. When the truck 100 is an articulated vehicle, it is preferable to apply this embodiment not only to the tractor but also to the trailer.

### REFERENCE SIGNS LIST

100 Truck (Vehicle)
200 Front suspension (Air suspension)
220R, 220L Air spring
300 Rear suspension (Air suspension)
320R, 320L Air spring
400 Air reservoir
440R, 440L Magnetic valve
450 Electronic control unit
450A Processor
450B Non-volatile memory
470 Steering angle sensor (Sensor)

1. A method for controlling air suspensions, performed by an electronic control unit containing a microcomputer, comprising the steps of:
calculating operation variables of left and right air springs of air suspensions based on a steering angle and a roll angle of a vehicle; and
controlling air pressures of the left and the right air springs in accordance with the calculated operation variables.

2. The method for controlling air suspensions of claim 1, performed by the electronic control unit, further comprising the step of:
estimating the roll angle by applying a Kalman filter to the steering angle.

3. The method for controlling air suspensions of claim 2:
wherein, in the step of estimating the roll angle, an identity observer using the Kalman filter is used to reduce estimation error.

4. The method for controlling air suspensions of claim 1:
wherein, in the step of calculating operation variables, the operation variables are calculated based on the roll angle adjusted in consideration of a feedback gain of an optimal control law.

5. The method for controlling air suspensions of claim 1:
wherein the step of controlling the air pressures of the left and the right air springs is performed by outputting actuation signals individually to magnetic valves each configured to control a flow rate of air supplied from an air reservoir to the left or the right air springs and a flow rate of air discharged from the air springs.

6. An air suspension controller comprising:
a sensor configured to measure a steering angle of a vehicle; and
an electronic control unit containing a microcomputer;
wherein the electronic control unit is configured to:
estimate a roll angle by applying a Kalman filter to the steering angle measured by the sensor,
calculate operation variables of left and right air springs of air suspensions based on the measured steering angle and the estimated roll angle, and
control air pressures of the left and the right air springs in accordance with the calculated operation variables.

7. The air suspension controller of claim 6:
wherein the electronic control unit is configured to use an identity observer using the Kalman filter to reduce error in estimating the roll angle.

8. The air suspension controller of claim 6:
wherein the electronic control unit is configured to calculate the operation variables based on the roll angle adjusted in consideration of a feedback gain of an optimal control law.

9. The air suspension controller of claim 6:
wherein the electronic control unit is configured to control the air pressures of the left and the right air springs by outputting actuation signals individually to magnetic valves each configured to control a flow rate of air supplied from an air reservoir to the left or the right air springs and a flow rate of air discharged from the air springs.

10. An air suspension system comprising:
air suspensions mounted on a vehicle;
an air reservoir configured to store air;
magnetic valves each configured to control a flow rate of air supplied from the air reservoir to left or right air springs of the air suspensions and a flow rate of air discharged from the air springs;
a sensor configured to measure a steering angle of a vehicle; and
an electronic control unit containing a microcomputer;
wherein the electronic control unit is configured to:
estimate a roll angle by applying a Kalman filter to the steering angle measured by the sensor,
calculate operation variables of the left and the right air springs of the air suspensions based on the measured steering angle and the estimated roll angle, and
control air pressures of the left and the right air springs in accordance with the calculated operation variables by outputting actuation signals individually to the magnetic valves.

11. The air suspension system of claim 10:
wherein the electronic control unit is configured to use an identity observer using the Kalman filter to reduce error in estimating the roll angle.

12. The air suspension system claim 10:
wherein the electronic control unit is configured to calculate the operation variables based on the roll angle adjusted in consideration of a feedback gain of an optimal control law.

13. A vehicle equipped with the air suspension system of claim 10.

14. A computer program comprising a program code which, when executed on a computer, causes the computer to perform the steps in the method for controlling air suspensions of claim 1.

15. A computer-readable medium carrying a computer program comprising a program code which, when executed on a computer, causes the computer to perform the steps in the method for controlling air suspensions of claim 1.
